(19) United States
(12) Patent Application Publication
(10) Pub. No.: US 2026/0185853 A1
(43) Pub. Date: Jul. 2, 2026

(54) ROTARY ENCODER

(71) Applicant: IGUS GMBH, Koeln (DE)

(72) Inventor: Thilo-Alexander JAEKER, Sankt Augustin (DE)

(21) Appl. No.: 18/855,415

(22) PCT Filed: Apr. 20, 2024
(86) PCT No.: PCT/EP2023/060366

§ 371 Date: Oct. 9, 2024

(30) Foreign Application Priority Data
Apr. 21, 2022 (DE) 20 2022 102 145.7

(51) Int. Cl. G01D 5/12; B65H 75/44; G01D 11/24

(52) U.S. Cl. CPC G01D 5/125; B65H 75/4402; G01D 11/245; G01D 2205/22; G01D 2205/26

(57) ABSTRACT

A rotary encoder for detection of rotary motion, optionally for multiple rotations, including a gear-like arrangement having a first component and a second component for a mechanical conversion of a rotary motion into a linear translational motion, which changes an axial relative position between the first component and the second component and includes a distance sensor for determining a distance to a measurement object, the distance being dependent on the relative axial position. The first component and the second component are manufactured as molding parts made of plastic, optionally as injection molding parts, and the gear-like arrangement includes, at the first component, a thread which engages with a second thread at the distance sensor and/or at the second component for a mechanical conversion of a rotary motion into a linear translational motion.

### FIELD

The invention relates in general to the field of devices for detecting rotary motions, e.g. angles of rotation and changes in angles of rotation, wherein a mechanical conversion of the rotary motion into another motion takes place for detection.

The invention relates in particular to a rotary encoder for detection of rotary motion about an axis of rotation and to a device including a rotary encoder.

### BACKGROUND

With such rotary encoders, a distinction is made between incremental rotary encoders and absolute rotary encoders. Incremental rotary encoders are suitable for detecting an angular change caused by a rotary motion relative to an angular reference within an angular range. Absolute rotary encoders are suitable for detecting every angular position that can be achieved by a rotary motion as absolute values that can be clearly assigned over their entire intended angular range. Absolute rotary encoders are often limited to a small angular range. Reliable detection of rotary motions usually requires devices with sensitive sensor components and specially adapted precision components, which makes the devices complex and prone to wear.

The invention relates in particular to an absolute rotary encoder which is also suitable for detection of an absolute angle in the case of multiple rotations.

Rotary encoders in the field of the invention convert a rotary motion mechanically into a translational motion in order to detect it. This is desirable for some applications because a path of a translational motion is often easier to detect and the conversion can also facilitate detection in the case of multiple rotations.

Various solutions are known for converting the rotary motion into the translational motion. One known solution is for the rotary encoder to include a gear-like arrangement in the form of a helical gear, the components of which convert the rotary motion into a linear translational motion by changing an axial relative position of the components to one another.

Preferably, such rotary encoders include a distance sensor coupled to the components for determining a distance to a measurement object, wherein the distance changes when an axial relative position changes. In general, distance sensors are to be distinguished from so-called proximity sensors, which detect the presence of a measurement object in a distance range and output a proximity signal dependent thereon.

Previous solutions are expensive to manufacture due to the need for specially matched gear components and have to be specially protected when used in harsh conditions.

### SUMMARY

An object of the invention is to provide a rotary encoder that is as simple as possible in its construction and/or that can be manufactured at a low cost. The rotary encoder should nevertheless be configured to be as robust as possible against environmental influences.

The problem is solved in that a first component and a second component of a gear-like arrangement of the rotary encoder are manufactured as molding parts made of plastic and in that the gear-like arrangement has a first thread on the first component, which engages with a second thread at the distance sensor and/or at the second component for a mechanical conversion of a rotary motion into a linear translational motion.

Such a rotary encoder for detection of rotary motion according to the invention includes the gear-like arrangement including the first component and the second component. Preferably, the first component is made in one piece and/or the second component is made in one piece. Preferably, at least one of these components is manufactured as an injection molding part; in particular, both components may be manufactured as injection molding parts made of plastic.

The gear-like arrangement is configured to mechanically convert the rotary motion into the linear translational motion, which changes an axial relative position between the first component and the second component. The gear-like arrangement is in general to be understood as an arrangement that is configured to convert one motion into another motion. This may be done by interaction with other components, but in particular independently of them. Preferably, the linear translational motion runs axially, i.e. technically parallel to or along an axis of rotation associated with the rotary motion.

In a preferred embodiment, the rotary encoder is configured as an absolute rotary encoder. Preferably, the rotary encoder is suitable for multiple rotations, in particular over a rotation angle range of at least five, in particular over at least ten, e.g. over at least twenty-five, rotations. Preferably, the rotary encoder has stop regions for limiting its angle of rotation range.

The rotary encoder includes a distance sensor for determining a distance to a measurement object, the distance being dependent on the relative axial position. The measurement object may be an arbitrarily defined area, a measurement surface, a measurement point, or the like. The measurement object may be part of the rotary encoder, in particular part of one of the components. However, the measurement object may also be separate from the first component and the second component, e.g. may be part of an external device.

The distance sensor is particularly preferably configured as a non-contact distance sensor, which means that no direct physical contact with the measurement object is required to determine the distance from the measurement object. Preferably, the distance sensor consists of components that are immovable relative to each other. Preferably, the first thread and the second thread run along the axis of rotation. Preferably, the distance sensor is radially enclosed by the first component and/or the second component, which ensures improved protection of the distance sensor against environmental influences.

Generally preferred, at least the first thread or the second thread includes a constant thread geometry, in particular a continuous thread web, in particular a constant thread depth, in particular a constant thread pitch. This enables a reliably guided interlocking of the threads. In an embodiment, at least one of the two threads is interrupted in sections, which in particular enables the respective thread to be used with different threads.

Due to the described interaction of the first and second components by means of the first and second threads, the rotary encoder may have a particularly simple structure, which enables a cost-effective and robust design of the rotary encoder that is particularly suitable for mass production. Compared to conventional rotary encoders, the number of components required to realize the rotary encoder is reduced to a minimum. The inventors have also found that by suitably tuning the threads, accurate detection of the rotary motion for industrial purposes can be guaranteed even when using inexpensive distance sensors with lower accuracy.

In an embodiment, the first thread is manufactured jointly and/or integrally with the first component. In an embodiment, the first thread is manufactured separately from the first component and joined to the first component, in particular in a form-fitting manner. Preferably, the first thread may be made of a material different from a material of the first component.

In an embodiment, at least a part of the second thread engaging with the first thread is manufactured jointly and/or integrally with the second component. This may apply, in particular, to at least 50%, in particular at least 70%, of the axial length of the second thread. In an embodiment, the second thread is manufactured separately from the second component and joined to the second component, in particular in a form-fitting manner. Preferably, the second thread may be made of a material different from a material of the second component.

The integral manufacturing of the thread and the component further simplifies the design of the rotary encoder.

In a preferred embodiment, at least a portion of the second thread which engages with the first thread is made integral with at least a portion of the distance sensor. This may apply, in particular, to at least 50%, in particular at least 70%, of the axial length of the second thread.

The distance sensor may include a sensor housing and a sensor component, whereby the sensor housing encloses the sensor component, in particular in a fluid-tight manner. The sensor component serves to detect the distance to the measurement object. The sensor component is easily protected by the sensor housing. Preferably, the aforementioned portion of the distance sensor is part of the sensor housing. A portion of the second thread may therefore be provided on the sensor housing, in particular may be manufactured integrally with it. In particular, the sensor housing is made of metal, which on the one hand ensures improved protection of the sensor component and on the other hand enables an advantageous sliding pairing with a first thread made of plastic when the thread is integral.

In an embodiment, the second thread is implemented as an internal thread pointing to the first component. In an embodiment, the second thread is configured as an external thread pointing to the first component. In particular, the first thread points to the distance sensor.

According to an advantageous embodiment, at least the first thread or the second thread, i.e. optionally the first thread and the second thread, include a flank angle which is at least 40°, in particular at least 55°, in particular between 55° and 65°. The flank angle describes an angle between axially facing flanks of two adjacent thread turns of a thread. The first thread and/or the second thread are particularly preferably configured as a metric, in particular as an ISO metric, thread, in particular as a standard thread or fine thread, particularly preferably as an M12 thread. Preferably, the first thread and the second thread have a nominal diameter of at least 5 mm, preferably a maximum of 20 mm. Such threads are widely used as attachment threads due to their steep flank angle. However, it has been found that a reliable mechanical conversion of the rotary motion into a linear translational motion is nevertheless guaranteed, making the rotary encoder even simpler and more cost-effective to manufacture.

Particularly preferably, the first thread and the second thread are configured in such a way that the gear-like arrangement converts a rotary motion executed around a single revolution into a linear translational motion over a, in particular axial, path of 0.25 mm to 25 mm, in particular from 0.5 mm to 10 mm, in particular from 1 mm to 2.5 mm. For this purpose, the first thread and the second thread include corresponding thread pitches. Particularly preferably, the path of the linear translational motion over a single revolution corresponds to the thread pitch of the respective thread. Generally preferred is a maximum path of the linear translational motion of at least 5 mm, in particular at least 15 mm, in particular not more than 60 mm.

In an advantageous embodiment, the distance sensor is configured at least as an inductive sensor. In an advantageous embodiment, the distance sensor is configured at least as a capacitive sensor. In an embodiment, the distance sensor is configured at least as an optical sensor.

In general, the distance sensor may preferably include further components operating according to different measurement principles, for example to increase measurement accuracy. In a preferred embodiment, the distance sensor is configured to determine the distance to the measurement object by a time-of-flight measurement, i.e. by determining a time required for a signal to pass through a measurement path between the distance sensor and the measurement object. It is in general preferred that the distance sensor and the measurement object are arranged one behind the other without overlapping. Preferably, the distance sensor is configured to detect a different inductance, a different capacitance, and/or a different time-of-flight of a signal for each distance of the distance sensor to the measurement object that is dependent on the relative axial position.

In an embodiment, the measurement object is configured as a flat area pointing axially towards the distance sensor. In a preferred embodiment, the measurement object is configured as a plate, in particular one made of metal. A measurement object made of metal can interact advantageously with capacitive or inductive sensors. Optionally, the plate is supported axially on the first component, such as an axial distal end of the first component. In another embodiment, the plate is omitted, wherein the rotary encoder may be arranged on a machine part in such a way that the distance sensor can determine a distance, dependent on the axial relative position, to a region of the machine part serving as a measurement object, in particular pointing towards the distance sensor. Such a machine part is preferably configured as a shaft, axle or bushing.

In an advantageous embodiment, the distance sensor is attached to the second component in a rotationally fixed manner, in particular in a positionally fixed manner. For this purpose, the second component preferably has a sensor attachment that interacts with the distance sensor force fitting and/or form fitting to attach the distance sensor to the second component.

In particular, the sensor attachment for attachment of the distance sensor engages radially in a recess of the distance sensor and/or clamps the distance sensor radially relative to the second component.

In an embodiment, the distance sensor is adhered and/or welded to the second component in a positionally fixed manner. This makes it particularly easy to manufacture the rotation angle sensor and can help to protect the distance sensor from environmental influences.

To attach the rotary encoder to machine parts, which are rotatable relative to one another, the first component and the second component each include an attachment region in an advantageous embodiment. The respective attachment region enables, in particular optionally, an axially attachment in a positionally fixed manner to the respective machine part and/or an axially displaceable attachment to the respective machine part. One of the two components, in particular the first component, is attachable axially in a positionally fixed manner to a first machine part of the machine parts by means of its attachment region and the other one of the two components, in particular the second component, is attachable axially displaceably, and in particular in a rotationally fixed manner, to a second machine part of the machine parts by means of its attachment region. This makes tilting unlikely when the relative position between the two components is changed.

According to a preferred embodiment, the first component and/or the second component are made of a same fiber-reinforced plastic, optionally a glass fiber-reinforced plastic and/or a carbon fiber-reinforced plastic. It is particularly preferred that the first component and the second component are made of the same plastic material, in particular a plastic material that has been tribologically optimized, for example by enrichment with solid lubricants.

Particularly preferably, the rotary encoder includes a guide by means of which the first component and the second component are displaceably guided axially, in particular slidingly, relative to one another. Particularly preferably, the guide is realized by axially extending, in particular cylindrical, guide surfaces of the first component and of the second component sliding against each other. The guide prevents the components from tilting when the axial relative position is changed.

In general, preferably, the first component and the second component are arranged coaxially to the distance sensor. Preferably, the first component and the second component are arrangeable coaxially to an axis of rotation of machine parts that are rotatable relative to one another for detection of a rotary motion of these machine parts relative to one another. Preferably, the distance sensor is arrangeable coaxially to this axis of rotation. In general, preferably, the rotary encoder is substantially rotationally symmetrical about the axis of rotation.

In particularly compact embodiments, the rotary encoder consists of a maximum of six, in particular a maximum of four, separate components, for example the first component, the second component, the distance sensor and a separate measurement object. In addition, further components may be provided for mounting or coupling the rotary encoder. The rotary encoder preferably consists of the first component, the second component, and the distance sensor. In particular, the first component or the second component includes the measurement object.

In a particularly cost-effective embodiment, the first component and/or the second component are configured as a single piece. It is particularly preferred that the first component is configured as a one-piece or one-part injection molding part, preferably made of a thermoplastic, and/or the second component is configured as a one-piece or one-part injection molding part, preferably made of a thermoplastic. The used plastic material may be fiber-reinforced in one or both components.

According to a further aspect, the invention provides a device including a rotary encoder with features according to the invention. The device serves for winding and unwinding a cable guiding device, in particular an energy guiding chain, for a protected guidance of lines, cables, hoses, or the like between a first connection position and a second connection position movable relative to the first connection position. The device particularly preferably includes the cable guiding device, e.g., the energy guiding chain. The device includes a holder and a reel rotatably mounted on the holder for winding and unwinding the cable guiding device. The rotary encoder is arranged on the reel for detection of a rotary motion of the reel when winding and unwinding the cable guiding device. Particularly preferably, one of the components of the first component and the second component of the rotary encoder is coupled in a rotationally fixed manner to the reel and the other one of the components is coupled in a rotationally fixed manner to the holder for mechanically converting the rotary motion of the reel into a linear translational motion, which changes an axial relative position between the two components during a rotary motion of the reel relative to the holder.

According to a further aspect, the invention relates to a method for detecting a rotary motion, in particular multiple rotations, in particular by means of a rotary encoder according to the invention. A gear-like arrangement mechanically converts the rotary motion into a linear translational motion by means of a first thread on a first component, which engages with a second thread on a second component and/or on a distance sensor. The translational motion changes a distance of a distance sensor to a measurement object, wherein a distance signal dependent on the distance is output to indicate the rotary motion. Further, the invention relates to a use of the rotary encoder for detection of a rotary motion. The method and/or the use may have features which are described above in connection with the rotary encoder and/or the device.

### BRIEF DESCRIPTION OF THE DRAWINGS

Further advantageous features and effects of the invention are explained below—without limiting the generality of the foregoing—by means of preferred embodiments with reference to the accompanying figures. It shows:

FIG. 1A is a schematic principle drawing of an oblique view of a first exemplary embodiment of a rotary encoder according to the invention;

FIG. 1B is a sectional view of the exemplary embodiment of FIG. 1A;

FIG. 2A is a schematic principle drawing of an oblique view of a second exemplary embodiment of the rotary encoder;

FIG. 2B is a sectional view of the exemplary embodiment of FIG. 2A; and

FIG. 3 is a schematic principle drawing of a device according to the invention with rotary encoder for winding and unwinding a cable guiding device.

### DETAILED DESCRIPTION

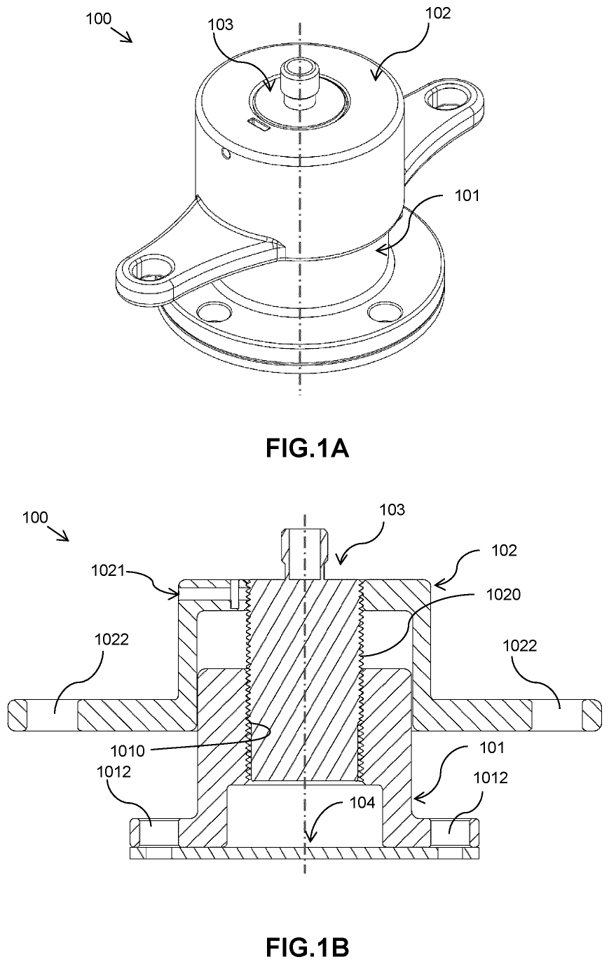

FIGS. 1A-1B show a first exemplary embodiment of the rotary encoder 100 according to the invention. The rotary encoder 100 includes a gear-like arrangement having a first component 101 and a second component 102 as well as a distance sensor 103. The distance sensor 103 is arranged in the first component 101 and in the second component 102 and is coupled to the first component 101 and the second component 102. The second component 102 includes a pot-like section in which the first component 101 is accommodated in a sectional manner. The distance sensor 103, the first component 101, and the second component 102 are arranged coaxially to a common axis of rotation.

The first component 101 includes a first thread 1010 formed integrally with the first component 101, the first thread 1010 engaging with a second thread 1020 formed integrally with a sensor housing of the distance sensor 103. The second thread 1020 extends over approximately 70% of the axial extent of the sensor housing. The second component 102 includes a further thread which engages with the second thread 1020 of the distance sensor 103 for axial fixation of the second component 102 to the distance sensor 103.

The distance sensor 103 is directed towards a plate arranged at one end of the first component 101, whose area facing the distance sensor 103 serves as a measurement object 104 for the distance sensor 103 to determine a free distance between the measurement object 104 and the distance sensor 103. The distance between the measurement object 104 and the distance sensor 103 depends on a relative position between the first component 101 and the second component 102, i.e. on a position of the first component 101 relative to the second component 102.

A rotary motion of the first component 101 and of the second component 102 relative to each other is converted into a linear translational motion along the axis of rotation by the interaction of the first thread 1010 and the second thread 1020 in the manner of a gear. This changes the relative axial position between the first component 101 and the second component 102. When the axial relative position between the first component 101 and the second component 102 changes, the distance between the measurement object 104 and the distance sensor 103 changes accordingly.

The distance sensor 103 is at least partially accommodated in a suitably configured receptacle in the second component 102 and is attached to it axially and in a rotationally fixed manner. As a sensor attachment 1021, the second component 102 includes a radial opening and an axial recess, into which a nut (not shown) is inserted in a non-rotatable manner. A threaded part (not shown) is inserted into the radial opening and screwed to the nut in such a way that it presses the distance sensor 103 in its receptacle radially against the body of the second component 102 to produce an at least force-locking anti-rotation lock for the distance sensor 103 relative to the second component 102.

The distance sensor 103 is preferably configured as a commercially available inductive sensor which interacts with the measurement object 104 in such a way that a change in the distance between the distance sensor 103 and the measurement object 104 causes a change, proportional to the distance between the distance sensor 103 and the measurement object 104 in the axial direction, in an inductance detected by the distance sensor 103, which can be tapped as a signal, e.g. corresponding to a variable analog voltage. The plate may be omitted if the rotary encoder 100 is attached to a machine part in such a way that a metallic area of the machine part facing the distance sensor 103 itself provides the measurement object 104 for determining the distance dependent on the relative axial position.

In FIGS. 1A-1B, the first component 101 and the second component 102 are in sliding contact with each other with cylindrical surfaces. This provides a guide for the first component 101 and the second component 102 relative to each other, which ensures a largely tilt-free alignment of the first component 101 and the second component 102 relative to each other and thus the desired alignment of the distance sensor 103.

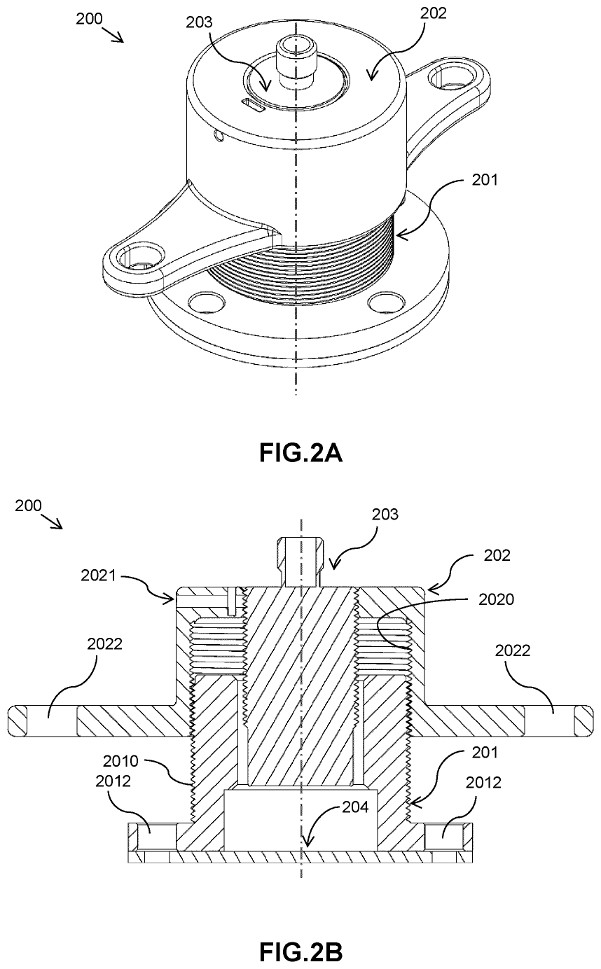

At its end pointing axially away from the second component 102, the first component 101 includes a flange region with through-holes as attachment region 1012 for axial attachment to a first machine part in a positionally fixed manner. The attachment region 1012 of the first component 101 is also provided for attaching the plate to the first component 101. The second component 102 includes arms which extend radially away from a pot-shaped region and at the radial ends of which through-holes are provided as attachment region 1022 for axially movable attachment to a second machine part. The arms extend radially beyond the first component 101, so that the attachment region 1022 is arranged outside the radial extension of the first component 101. The sections of the sectional views in FIG. 1A and FIG. 2A run through the respective arms and the respective axis of rotation of the respective rotation angle sensor 100, 200.

The first machine part and the second machine part (both not shown) rotate relative to each other during operation, generating a rotary motion to be detected by the rotary encoder 100. The through-holes are configured as elongated holes. The coupling to the second machine part can be made, for example, by means of pins guided axially through the elongated holes of the attachment region 1022. The axis of rotation of the machine parts, which rotate relative to each other during operation, coincides with the axis of rotation of the rotary encoder 100. When the coupled machine parts rotate, their rotary motion is transferred to the rotary encoder 100 via the attachment regions 1012, 1022 and converted into a linear translational motion to change the relative position of the first component 101 and the second component 102. The attachment region is axially movably and in a rotationally fixed manner secured to the second component 102 by the attachment region 1022 when the relative position relative to the pins is changed. By providing elongated holes, which extend radially to the axis of rotation, seizing can be avoided when the relative position is changed.

The distance sensor 103 includes a sensor connection for connection to an evaluation device on a side pointing axially away from the measurement object 104.

FIGS. 2A-2B shows a second exemplary embodiment of the rotary encoder 200 according to the invention. The second exemplary embodiment includes a large number of features identical to the first exemplary embodiment, so that in the following only different features will be discussed. As in the first exemplary embodiment, the distance sensor 203 includes a thread. In contrast to the first exemplary embodiment, the thread is not configured to interact with the first thread 2010 of the first component. The first thread 2010 is configured as an external thread pointing towards the second component 202. The second thread 2020, which interacts with the first thread 2010, is configured to be integral with the second component 202. The components 201, 202 are not guided by direct sliding contact, as the threads 2010, 2020 are arranged in the area of the cylindrical surfaces. The distance sensor 203 is configured as a capacitive sensor that interacts with the measurement object 204 in such a way that a change in the distance of the distance sensor 203 relative to the measurement object 204 causes a change in a capacitance detected by the distance sensor 203 that is proportional to the distance between the distance sensor 203 and the measurement object 204 in the axial direction. The first thread 2010 and the second thread 2020 cooperate to convert a rotary motion of the first component 201 relative to the second component 202 about an axis of rotation into a linear translational motion that changes an axial relative position between the first component 201 and the second component 202.

By configuring the first thread 2010 on the first component 201 and the second thread 2020 on the second component 202, an adapted thread geometry may be selected without reworking a provided distance sensor 203, making the gear-like arrangement compatible with a large number of distance sensors. The first thread 2010 may also be manufactured integrally with the first component 201 at low cost and the second thread 2020 may also be manufactured integrally with the second component 202 at low cost. In addition, a thread length of the first thread 2010 and/or the second thread 2020 may be selected independently of an extension of the distance sensor 203.

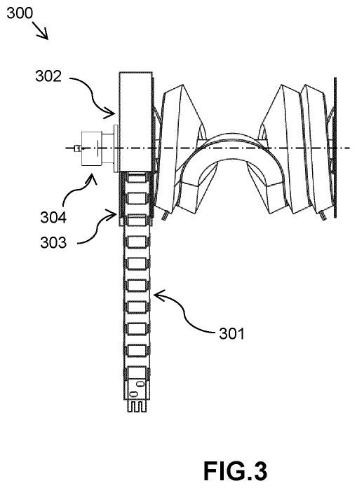

FIG. 3 shows a schematic principle drawing of an exemplary embodiment of a device 300 for winding and unwinding a cable guiding device 301 according to the invention. The device 300 includes a holder 302 on which a reel 303 is rotatably mounted. The cable guiding device 301 may be wound or unwound on the reel 303 while generating a rotary motion of the reel 303 relative to the holder 302 about an axis of rotation.

A rotary encoder 304 according to the invention is coaxial with the axis of rotation, wherein in principle a coaxial position may deviate from an ideal coaxial position for manufacturing or design reasons, and is attached to an axial end of the holder 302 and the reel 303. One of the two components of the rotary encoder 304 is attached to the holder 302 and the other one of the components is attached to the reel 303. This allows the rotary encoder 304 to detect the rotary motion of the reel 303 relative to the holder 302 when winding and unwinding the cable guiding device 301.

Reference sign list

| | |
|---|---|
| 100 | rotary encoder |
| 101 | first component |
| 102 | second component |
| 103 | distance sensor |
| 104 | measurement object |
| 200 | rotary encoder |
| 201 | first component |
| 202 | second component |
| 203 | distance sensor |
| 204 | measurement object |
| 300 | device |
| 301 | cable guiding device |
| 302 | holder |
| 303 | reel |
| 304 | rotary encoder |
| 1010 | first thread |
| 1012 | attachment region |
| 1020 | second thread |
| 1021 | sensor attachment |
| 1022 | attachment region |
| 2010 | first thread |
| 2012 | attachment region |
| 2020 | second thread |
| 2021 | sensor attachment |
| 2022 | attachment region |

What is claimed is:

1-18. (canceled)

19. A rotary encoder, optionally an absolute rotary encoder, for detection of rotary motion, for multiple rotations, comprising:
a gear-like arrangement, having a first component and a second component, for a mechanical conversion of a rotary motion into a linear translational motion, which changes an axial relative position between the first component and the second component;
a distance sensor, in particular a non-contact distance sensor, for determining a distance to a measurement object, the distance being dependent on the relative axial position; wherein:
the first component and the second component are manufactured as molding parts made of plastic, in particular as injection molding parts; and
the gear-like arrangement comprises, at the first component, a first thread which engages with a second thread at the distance sensor and/or at the second component for a mechanical conversion of a rotary motion into a linear translational motion.

20. The rotary encoder according to claim 19, wherein the first thread is manufactured integrally with the first component, wherein preferably at least the first component and/or the second component is manufactured as a one-piece molding part made of plastic.

21. The rotary encoder according to claim 19, wherein at least part of the second thread, which engages with the first thread, is manufactured integrally with the second component.

22. The rotary encoder according to claim 19, wherein at least part of the second thread, which engages with the first thread, is manufactured integrally with a portion of the distance sensor, in particular with a sensor housing of the distance sensor, which encloses a sensor component of the distance sensor, in particular in a fluid-tight manner.

23. The rotary encoder according to claim 21, wherein the second thread is configured as an internal thread pointing towards the first component.

24. The rotary encoder according to claim 22, wherein the second thread is configured as an external thread pointing towards the first component.

25. The rotary encoder according to claim 19, wherein the first thread and/or the second thread comprises a flank angle of at least 40°, in particular of at least 55°.

26. The rotary encoder according to claim 19, wherein the first thread and the second thread comprise corresponding thread pitches such that the gear-like arrangement converts a rotary motion executed around a single revolution into a linear translational motion over a path of 0.25 mm to 25 mm, in particular of 0.5 mm to 10 mm.

27. The rotary encoder according to claim 19, wherein the distance sensor is configured at least as an inductive sensor or as a capacitive sensor, wherein optionally the distance sensor and the measurement object are arranged axially one behind the other without overlapping.

28. The rotary encoder according to claim 27, wherein the measurement object is configured as a plate, which is in particular made of metal and which is in particular axially supported on the first component.

29. The rotary encoder according to claim 19, wherein the distance sensor is attached in a rotationally fixed manner, in particular in a positionally fixed manner, to the second component, in particular by means of a sensor attachment of the second component, which interacts with the distance sensor force fitting and/or form fitting for attachment.

30. The rotary encoder according to a claim 19, wherein the first component and the second component each comprise an attachment region for attachment to machine parts that are rotatable relative to one another, wherein:
one of the two components can be, by means of its attachment region, attached axially in a positionally fixed manner to a first one of the machine parts; and
the other one of the two components can be, by means of its attachment region, attached axially movably on a second one of the machine parts.

31. The rotary encoder according to claim 19, wherein the first component and/or the second component are made of a same fiber-reinforced plastic.

32. The rotary encoder according to claim 19, wherein the first component and the second component are guided axially, in particular slidingly, movably relative to one another by a guide.

33. The rotary encoder according to claim 19, wherein the first component and the second component are arranged coaxially to the distance sensor and/or can be arranged coaxially to an axis of rotation of machine parts which are rotatably relative to one another for detection of a rotary motion of the machine parts.

34. The rotary encoder according to claim 19, wherein the rotary encoder consists of the first component, the second component and the distance sensor.

35. The rotary encoder according to claim 19, wherein the first component is formed in one piece and/or the second component is formed in one piece, wherein in particular the first component and/or the second component are formed as injection molding part.

36. A device for winding and unwinding a cable guiding device, in particular an energy guiding chain, for a protected guidance of lines, cables, hoses, or the like between a first connection position and a second connection position movable relative to the first connection position; comprising:
a reel rotatably mounted on a holder for winding and unwinding the cable guiding device; comprising:
a rotary encoder according to claim 19 arranged on the reel for detection of a rotary motion of the reel when winding and unwinding the cable guiding device.
